(19) United States
(12) Patent Application Publication
(10) Pub. No.: US 2003/0044675 A1
(43) Pub. Date: Mar. 6, 2003

(54) Longlife storage battery

(76) Inventor: Thomas G. Packard, Edmonds, WA (US)

Correspondence Address: THOS. G. PACKARD, 7005 150thPL. SW., EDMONDS, WA, 98026, US

(21) Appl. No.: 10/222,040

(22) Filed: Aug. 16, 2002

Related U.S. Application Data
(60) Provisional application No. 60/316,159, filed on Aug. 30, 2001.

(51) Int. Cl. H01M 2/38; H01M 2/36

(52) U.S. Cl. 429/72; 429/81; 429/68

(57) ABSTRACT

A storage battery is constructed for extended periods non use and still maintain a charge and have a long operational life by allowing for the separation of the electrolyte from electrodes within the battery in rapid, and safe manner.

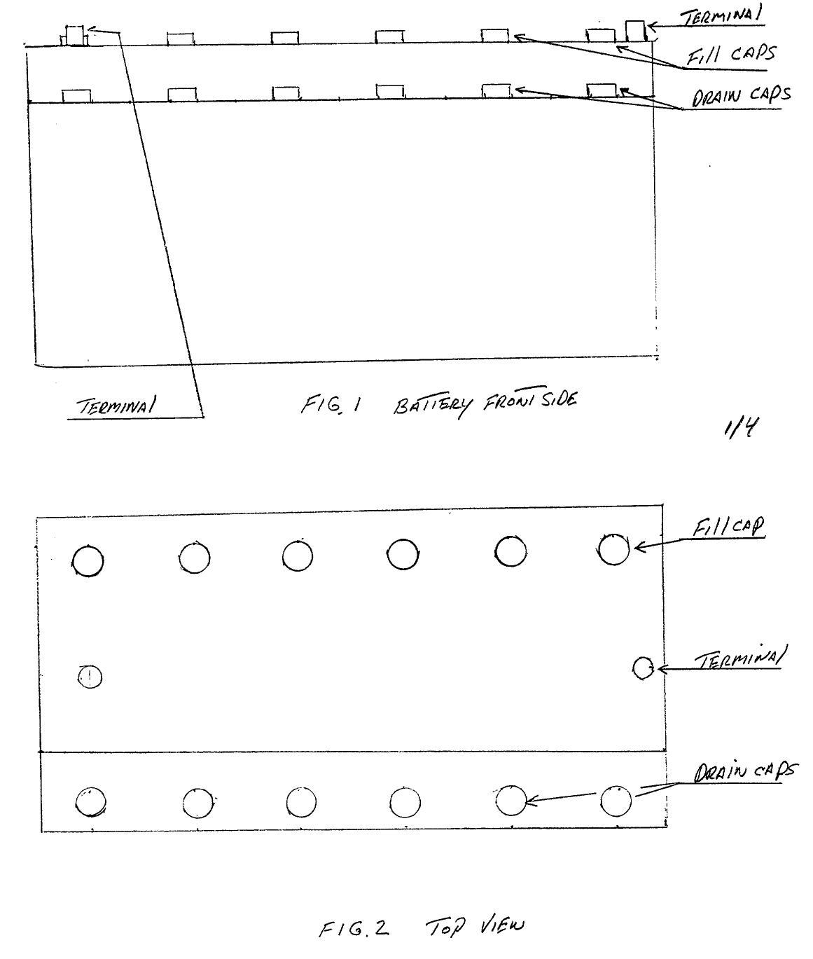

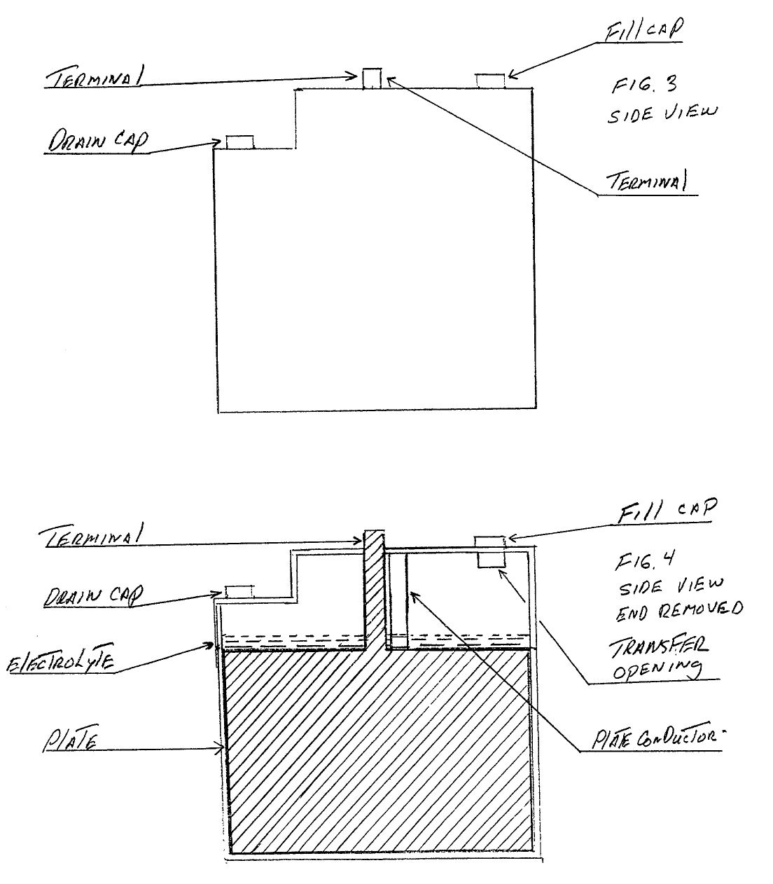

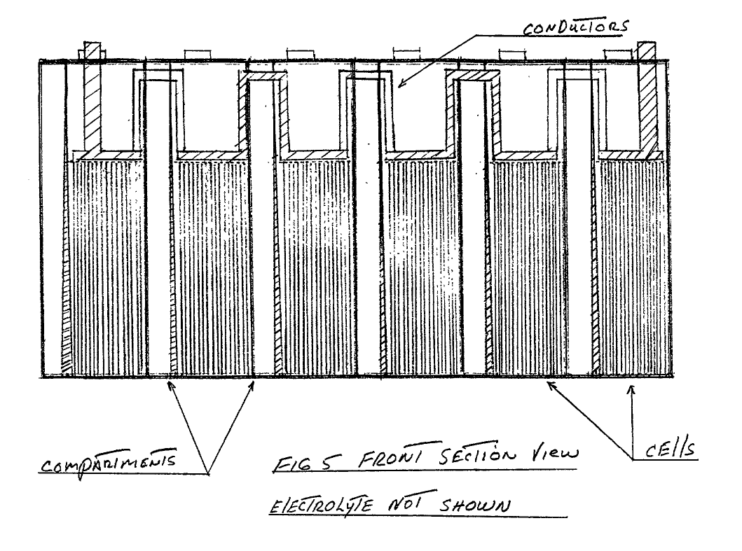

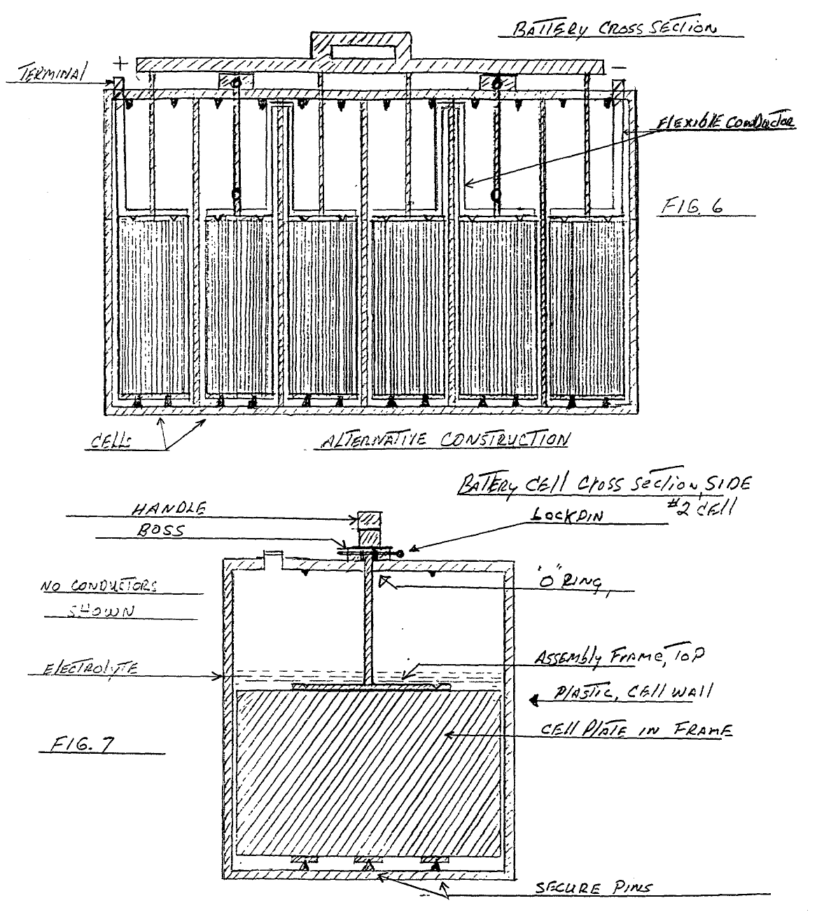

### BACKGROUND OF THE INVENTION

Electrical storage batteries slowly degrade over time when not in use due to internal chemical reactions. If the storage time is extended the battery will lose its charge and will not be rechargeable. The life of the battery will be over and new replacement battery will then be required.

### BRIEF SUMMARY OF THE INVENTION

This invention prevents the deteriorating internal chemical reactions that occur during extended storage by allowing for the separation of the battery electrodes from the electrolyte. This can be accomplished by constructing each battery cell with an adjacent compartment such that when the battery tipped up on one end the electrolyte will flow into the adjacent compartment through a small opening/aperture in the top of the partition between battery cell and the associated compartment, this opening/aperture will also be offset to one side, when the electrolyte has fully drained from the battery cell, the battery is then returned to its normal upright position and the electrodes are now separated from almost all of the electrolyte. The battery caps are then removed and the cells are rinsed/flushed with clean water, preferably pure water while the compartment contained electrolyte is isolated and unaffected. The batter cells will be constructed with two external openings such that rinsing and draining the cells can be accomplished easily when the battery is turned on one side and the cells are drained of water while the electrolyte is still trapped in the compartments due to the opening being at the top and offset to the opposite side from the draining side. The battery is then returned to its original upright position and the cells are now filled with pure water and left in this position for several hours or perhaps a day to allow for internal diffusion to take place within plates themselves and remove trapped internal electrolyte. After sufficient time for diffusion the battery is once again turned on one side and drained, then returned to its upright position. The battery caps can then be replaced to seal the battery.

The batter is returned from storage when needed by tipping the battery up on the opposite end and the electrolyte will flow back from the adjacent compartments into the empty cells.

If the battery type is not lead-acid and does not require rinsing then the external drain openings are not required and the internal transfer openings/apertures do not require offseting.

Another way to accomplish the separation, depending upon the type of battery, is to construct the battery cell with more vertical height and pull the electrodes as singlecontained unit vertically up out of the electrolyte and locking them in this position.

### DETAILED DESCRIPTION OF THE INVENTION

A lead acid battery, 12 volts, comprised of six individual cells is constructed such that each cell has an associated compartment on the same respective side of each cell. Each associated compartment will have a transfer opening/aperture between the cell and the compartment, within the battery. These transfer openings or apertures will be at the top and offset to the back side of the common wall or partition between the cell and compartment, also the partitions will thicker at the bottom than at the top to assist in acid flow into and out of the compartments the compartments will be of the same length and heigth of the cells however the width will be less such that when the acid is poured from the cell into the compartment as the battery is raised up on one end to effect the acid transfer and then returned to the normal level position the resulting level of the acid will be no higher than it was in the cell. There may also be two small vent tubes near or at the opening to facilitate the passage of air to and from the compartment is necessary. The transfer openings or apertures may be in the form of simple openings, or valves to prevent acid flow and if necessary seal the compartments. Each cell will have two openings to the exterior of the battery itself at the top on opposing sides of the cell and one will be lower than the other to facilitate rinsing and draining. The higher fillers openings will have caps that will have a vent mode and a seal mode. The lower drain caps would only seal. For long term storage the battery would be charged and then slowly raised on the cell end to allow all the compartments to fill with acid then returned to the level position. All the filler/drain caps would then be removed and the cells would be rinsed by pouring water into the higher filler and letting it flow out the lower drain. After rinsing for a few minutes the battery would turned completely on its side and thoroughly drained. Then returned to upright and filled with water and left for a period of time for internal plate diffusion. When sufficient diffusion has taken place, perhaps a day, or less. The battery would once again turned on its side and drained. Then returned back to upright and capped/sealed for long term storage.

The battery is returned to use from storage by raising the compartment end fully such that all the electrolyte will flow out of the compartments and into the respective cells. Then returned to the normal upright position and the caps put into the vent mode.

This battery construction is also applicable to other battery types, with minor changes if necessary.

The battery may have an alternate construction in that each cell will not have an associated compartment however the relative heigth of the cell will be such that the cell electrode plate assembly can be raised up vertically out of the electrolyte. This is done by enclosing the electrode plate assembly in light plastic cage or frame on the top, bottom and sides, of the cell however the shorter width end sides generally will not require enclosing. The top center of the frame will have circular plastic rod that will extend from the frame up through a hole and O ring seal in the top of the cell and connect to a handle on the outside.

This handle will be common handle that will run along the top length of the battery and connect to the other cells. The handle and all the electrode plate assemblies will be locked in the up, storage position by inserting a tapered locking pin through a hole in the circular plastic rods and through two opposing holes in small ears or bosses on top of number #2 and #5 cell of the six cell battery. All the electrode plate assemblies will be locked in the down, operating position by similarly inserting the locking pins in another set of holes in circular plastic rods of #2 and #5 cell.

The bottom and top of the plastic frame assemblies will have tapered holes and pins to fit with tapered pins and holes at the bottom and top of the cell to secure and lock the plate assemblies in place.

The positive electrode plates of each cell will connected to one another at the top of the plate assembly, off set from the top center of the cell, by a solid metal conductor. The lead conductor will have flexible, plastic shelled/insulated, flat braded metal cable extending from it to another connecting metal conductor at the top of the cell when the cell electrode plate assemblies are in the normal lowered operating position the flexible metal cables would bend or bow toward outer ends of the cell. When the electrode plate assemblies are raised the flexible metal cables will bend and double over toward the outer ends of the cells.

The negative electrode plates of each cell will have a similar connecting system. The electrode plate assemblies will not have to be raised more than a few inches as the electrolyte level will lower disproportionately as the electrolyte volume is less then the displacing plate volume. The these types of battery construction are applicable to other liquid electrolyte or liquid electrode batteries such nicad, edison cell, etc.

I claim:

1. A battery, the cells of which will each have an associated and adjacent compartment into which electrolyte may be transferred and isolated and stored.

2. The battery of claim 1 wherein:
the compartments will have transfer openings/valves at the top of the compartment, and offset to one side, between the cells and adjacent compartments, within the battery.

3. The battery of claim 1 wherein:
the common wall or partition between each cell and compartment will be thicker at the bottom than at the top.

4. The battery of claim 1 wherein:
the cells of which will have two external openings in the upper/top areas, one for filling and one for draining, and the openings will have sealable caps.

5. The battery of claim 1 wherein:
the cells of which will have two external openings in the upper/top areas, one for filling and one for draining and the highest of the two cell openings will have a ventable as well as sealable cap.

6. The batter of claim 1 wherein:
the cells of which will have one external opening in the top and the external opening will have a cap that will have a ventable mode as well as sealable mode.

7. The battery of claim 1 wherein:
the compartments will have transfer openings/apertures at the top of the common wall or partition between each cell and its associated compartment that may incorporate closing/sealing valves.
claims
I claim:

8. A battery, the cell plates/electrodes of which, may be raised up and out of the cell electrolyte.

9. The battery of claim 8 wherein:
the cell plates/electrodes of all the cells may be simultaneously lifted out of the electrolyte and locked in this position.

10. The batter of claim 8 wherein:
the cell plates of all the cells may be simultaneously lowered into the electrolyte and locked down in this position.

11. The battery of claim 8 wherein:
the internal conductors of which are insulated and flexible/braded, as necessary for movement.
